(19) United States
(12) Patent Application Publication
(10) Pub. No.: US 2017/0052316 A1
(43) Pub. Date: Feb. 23, 2017

(54) APPARATUS FOR GENERATING MULTI-CHANNEL ARRAY LIGHT SOURCE BASED ON WAVELENGTH DIVISION MULTIPLEXING

(71) Applicant: ELECTRONICS AND TELECOMMUNICATIONS RESEARCH INSTITUTE, Daejeon (KR)

(72) Inventor: Oh Kee KWON, Daejeon (KR)

(73) Assignee: ELECTRONICS AND TELECOMMUNICATIONS RESEARCH INSTITUTE, Daejeon (KR)

(21) Appl. No.: 15/150,402

(22) Filed: May 9, 2016

(30) Foreign Application Priority Data
Aug. 18, 2015 (KR) 10-2015-0116230

(51) Int. Cl. G02B 6/12; G02B 6/293; H04J 14/02

(52) U.S. Cl. CPC G02B 6/12009; H04J 14/02; G02B 6/2938; G02B 2006/12164; G02B 2006/12161; G02B 2006/12142; G02B 2006/12121; G02B 2006/12123

(57) ABSTRACT

There is provided an apparatus for generating a multi-channel array light source based on wavelength division multiplexing (WDM). More specifically, the apparatus has a structure in which an optical multiplexer and distributed feedback laser diode (DFB-LD) array modules are coupled. The optical multiplexer is configured with a plurality of input port columns spatially spaced apart from each other, so that high-speed electrical signal lines, matching resistors, and DFB-LDs are integrated with each input port column. Accordingly, although a conventional apparatus is used as it is, the number of channels can be increased by two or three times without any large modification of the size of an optical device, and thus it is possible to achieve low-price, large-capacity communication. Based on this, it is possible to implement a low-priced 400-Gbps optical transceiver.

### CROSS-REFERENCE TO RELATED APPLICATION

The present application claims priority to Korean patent application number 10-2015-0116230 filed on Aug. 18, 2015 the entire disclosure of which is incorporated herein in its entirety by reference.

### BACKGROUND

1. Field

An aspect of the present disclosure relates to an apparatus for generating a light source, and more particularly, to an apparatus for generating a multi-channel array light source based on wavelength division multiplexing (WDM).

2. Description of the Related Art

With the spread of IP-TVs, broadband mobiles, and smart phones and the extension of cloud networks, demand for high-capacity, high-speed communication has explosively increased in recent years. In order to meet this demand, in Internet server and data centers, servers are continuously established, or the existing light sources are replaced by array light sources for high speed and large capacity.

Currently, a traffic of information communication in a data center frequently occurs in the data center (about 75%, and the other 25% occurs between data centers). The multi-source agreement (MSA) as a relative consultative group has selected a 10-Gbps distributed feedback laser diode (DFB-LD) array (10×10 Gbps) having 10 wavelength division multiplexing (WDM) channels as a form for realizing 100-Gbps communication in a data center, and detailed specifications of the 10-Gbps DFB-LD array has been continuously announced through several amendments.

Meanwhile, it is predicted that traffic in data centers will continuously increase, and hence discussion about the standard and specification of a form for realizing a 100-Gbps light source for data centers has started since the 100-Gbps light source was realized. Accordingly, studies on the realization of a light source having higher speed transmission performance are required.

### SUMMARY

Embodiments provide an apparatus for generating a multi-channel array light source based on wavelength division multiplexing (WDM).

According to an aspect of the present disclosure, there is provided an apparatus for generating a light source, the apparatus including: first and second distributed feedback laser diode (DFB-LD) array modules configured to receive an electrical signal input through a plurality of channels and output a plurality of optical signals modulated to have different wavelengths; and an optical multiplexer configured to output, to one output port, the plurality of optical signals output from the first and second DFB-LD array modules, wherein the first and second DFB-LD array modules are respectively connected to both sides parallel to the direction of the output port of the optical multiplexer.

The apparatus may further include a third DFB-LD array module connected to the opposite side to the output port of the optical multiplexer.

The first DFB-LD array module, the second DFB-LD array module, and the optical multiplexer may be integrated on a single semiconductor substrate.

The optical multiplexer may include an arrayed waveguide grating (AWG) configured to multiplex output signals of the first and second DFB-LD array modules and output the multiplexed signals.

Each of the first and second DFB-LD array modules may include: a plurality of channels configured to transmit/receive the electrical signal; DFB-LDs configured to respectively receive signals of the plurality of channels and perform optical modulation; and matching resistors configured to perform impedance matching of the plurality of channels with the DFB-LDs.

Each of the first and second DFB-LD array modules may be provided with 10 channels, and the optical modulation speed of the DFB-LDs of the first and second DFB-LD array modules may be 5 to 50 Gbps.

Each of the first, second, and third DFB-LD array modules may be provided with 10 channels, and the optical modulation speed of the DFB-LDs of the first, second, and third DFB-LD array modules may be 5 to 50 Gbps.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view showing a structure of a conventional 100-Gbps apparatus for generating a light source.

FIG. 2 is a view showing a structure of an apparatus for generating a light source according to a first embodiment of the present disclosure.

FIG. 3 is a view showing a structure of an apparatus for generating a light source according to a second embodiment of the present disclosure.

FIG. 4 is a view showing a structure of an apparatus for generating a light source according to a third embodiment of the present disclosure.

FIG. 5 is a view showing a structure of an apparatus for generating a light source according to a fourth embodiment of the present disclosure.

FIG. 6 is a view showing a structure of an optical multiplexer according to an embodiment of the present disclosure.

### DETAILED DESCRIPTION

Hereinafter, exemplary embodiments of the present disclosure will be described in detail with reference to the accompanying drawings.

In the following description, detailed explanation of known related functions and constitutions may be omitted to avoid unnecessarily obscuring the subject manner of the present disclosure.

However, the present disclosure is not limited to the embodiments but may be implemented into different forms. These embodiments are provided only for illustrative purposes and for full understanding of the scope of the present disclosure by those skilled in the art.

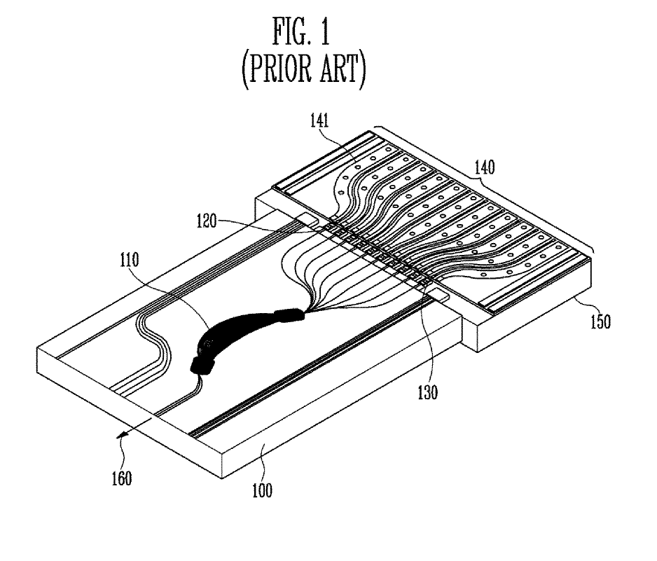

FIG. 1 is a view showing a structure of a conventional 100-Gbps apparatus for generating a light source.

Referring to FIG. 1, the apparatus is configured in a form in which 10-channel 10-Gbps distributed feedback laser diode (hereinafter, referred to as DFB-LD) array module 150 and an optical multiplexer 100 are hybrid-integrated. In FIG. 1, bonding wires for electrical connection for each component are omitted for convenience of illustration.

The DFB-LD array module 150 includes a plurality of DFB-LDs 120, a plurality of matching resistors 130, and a 10-channel flexible printed circuit board (FPCB) 140. Here, the 10-channel FPCB 140 includes 10 channels 141 for transmitting electrical signals.

In the DFB-LD array module 150, the DFB-LDs 120, the matching resistors 120, and the 10-channel FPCB 140 may be implemented in the form of one chip bar.

The 10-channel FPCB 140 is a ground-signal-ground (GSG) type grounded coplanar waveguide (GCPW) in which a metal is included in the bottom of a FPBC (designed to have an impedance of about 50 ohms). An S11 characteristic within about 15 dB and an S21 characteristic within about 2 dB are obtained at 40 GHz from the 10-channel FPCB 140 as a measurement result of S-parameters. If it is considered that a serial resistor of the DFB-LD 120 is about 5 ohms, a resistor of 45 ohms may be used as the matching resistor 130 for performing impedance matching.

The DFB-LD 120 connected to each of the channels 141 may generate a modulation light having a specific wavelength with respect to an injected electrical signal (current). The generated 10-channel light may be input to the optical multiplexer 100.

The DFB-LD 120 may have a wavelength channel interval of 8 nm at a center wavelength of 1550 nm.

The optical multiplexer 100 may include an arrayed waveguide grating (hereinafter, referred to as AWG) 110.

The 10-channel light generated in the DFB-LD array module 150 is incident to an input terminal of the AGW 110 as shown in FIG. 1, and the AWG 110 multiplexes optical signals for each wavelength and transmits the multiplexed signals to one output port 160.

Although two output waveguides of the AWG are illustrated in FIG. 1, this is provided by considering the movement of a transparent wavelength according to a process variable in the implementation of the AWG. In various embodiments, only a central output port 160 may be included.

In the conventional 100-Gbps apparatus of FIG. 1, a 10-Gbps modulation signal is applied to 10 input ports, and optical signals modulated to 10 Gbps in different channel wavelength by the respective DFB-LDs 110 pass through the AWG 110, thereby transmitting a 100-Gbps optical signal to the one output port 160.

In order to implement a 400-Gbps light source based on the implementation of a 100-Gbps light source, there may be considered a method of increasing a modulation speed for each channel or increasing the number of channels.

First, in order to implement the 400-Gbps light source, there may be considered a form in which a 40-Gbps light source array module is coupled to a 10-channel optical multiplexer. However, if it is considered that a 40-Gbps direct modulation DFB-LD is very expensive, the bandwidth of an ordinary DFB-LD is a maximum of 20 GHz, and the modulation factor (bps: bit per second) of a digital signal requires 70 to 80% of the bandwidth, the maximum modulation factor is limited to about 25 Gbps. Therefore, it may be realistically difficult to implement a low-price 10 channel * 40 Gbps array light source by using the direct modulation DFB-LD.

Next, in order to implement the 400-Gbps light source, there may be considered a form in which a 10-Gbps light source array module is coupled to a 40-channel optical multiplexer. However, in the configuration of a chip-bar DFB-LD array, as the number of arrays increases, the yield of a device rapidly decreases. In addition, unless an FPCB and matching resistors, located at an input port, are made of a high-priced material having a high dielectric constant, the interval between channels cannot be reduced. Therefore, as the number of channels increases, the width of the device increases. Accordingly, electrical signal lines and optical wavguides are gradually lengthened in the shape of curved lines, and hence channels located at the periphery of the device may cause high RF loss and optical loss.

Finally, in order to implement the 400-Gbps light source, there may be considered a form in which the channel modulation speed of a DFB-LD and the number of channels are properly increased, such as a 20-channel * 20-Gbps array light source in addition to the 10-channel * 40-Gbps array light source and the 40-channel * 10-Gbps array light source. However, in any case, an increase in the width of the device due to an increase in the number of channels and high electrical and optical loss of channels at the periphery of the device cannot be avoidable with the conventional implementation form.

Accordingly, in the present disclosure, there is proposed a new apparatus for generating a light source, which has a new structure obtained by modifying the conventional form in which the DFB-LD array module and the optical multiplexer.

That is, the present disclosure proposes a structure in which the number of channels can be increased up to two or three times without any large modification of the configuration of electrical components and devices, which are used in a conventional 100-Gbps light source. Thus, it is possible to prevent RF loss and optical loss due to an increase in the number of channels and, simultaneously, to propose an effective arrangement structure of light sources capable of performing low-price, large-capacity communication (e.g., 400 Gbps).

Hereinafter, for convenience of illustration, differences from the apparatus of FIG. 1 will be described, and descriptions of overlapping components will be replaced with those of FIG. 1.

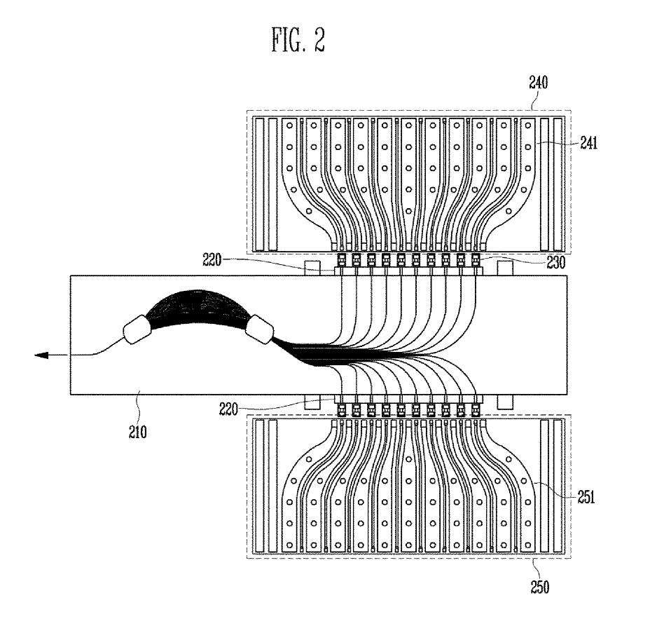

FIG. 2 is a view showing a structure of an apparatus for generating a light source according to a first embodiment of the present disclosure.

Referring to FIG. 2, the apparatus according to the embodiment of the present disclosure may include an optical multiplexer 210, a first DFB-LD array module 240, and a second DFB-LD array module 250.

As shown in FIG. 2, the apparatus is characterized in that the first DFB-LD array module 240 and the second DFB-LD array module 250 are disposed at upper and lower ends of the optical multiplexer 210, respectively. That is, the apparatus includes the first DFB-LD array module 240 connected to one side parallel to the direction of an output port of the optical multiplexer 210 and the second DFB-LD array module 250 connected to the opposite side.

The optical multiplexer 210 includes an AWG, and the AWG may multiplex optical signals for each wavelength, which are received through 20 channels, and transmit the multiplexed signals to one output port.

To this end, an input unit of the AWG may be provided with 10 input ports in each direction perpendicular to the direction of the output port of the optical multiplexer 210.

Each of the first DFB-LD array module 240 and the second DFB-LD array module 250 may include a plurality of DFB-LDs for generating a modulation light having a specific wavelength with respect to an injected electrical signal (current), channels 241 or 251 for transmitting electrical signals, and matching resistors 230 for performing impedance matching on the channels 241 or 251.

In various embodiments, each of the first DFB-LD array module 240 and the second DFB-LD array module 250 may include 10 DFB-LDs 220, 10 channels 241 or 251, and 10 matching resistors 230.

The DFB-LD 220 may generate a modulation light having a specific wavelength with respect to an injected electrical signal (current), and may have a wavelength channel interval of 8 nm at the center wavelength of 1550 nm.

The first DFB-LD array module 240 and the second DFB-LD array module 250 may be hybrid-integrated at the upper and lower ends of the optical multiplexer 210, respectively. According to the apparatus of FIG. 2, an output port of the AWG may generate a 400-Gbps optical signal (20 * 200 Gbps). In the above-described configuration, each of the channels 241 or 251 and the DFB-LDs 220 on a FPCB requires a 20-Gbps operation, and the form used in the conventional 100-Gbps apparatus can be used as the apparatus of this embodiment without any large modification, except that the form of the input ports of the AWG has been modified.

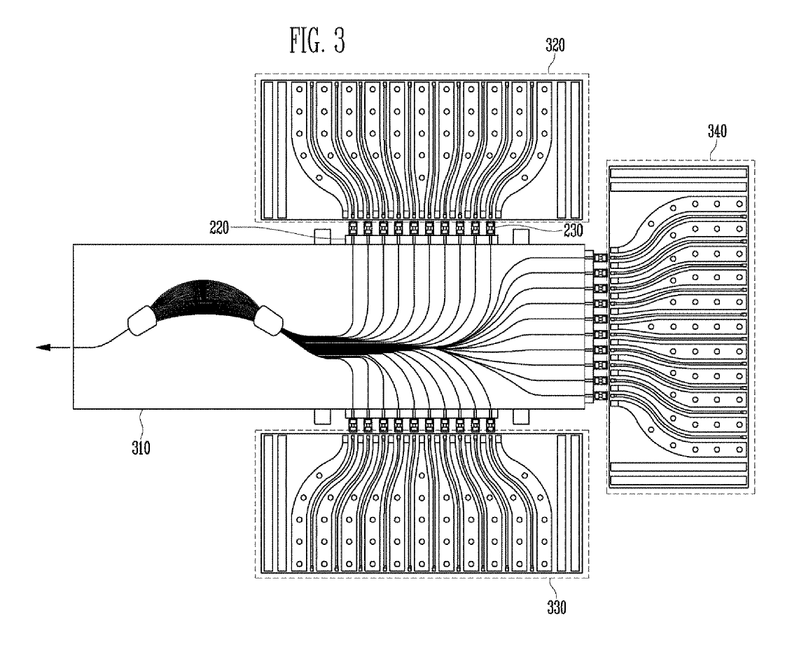

FIG. 3 is a view showing a structure of an apparatus for generating a light source according to a second embodiment of the present disclosure.

Referring to FIG. 3, the apparatus according to the embodiment of the present disclosure may include an optical multiplexer 310, a first DFB-LD array module 320, a second DFB-LD array module 330, and a third DFB-LD array module 340.

FIG. 3 shows a structure in which a DFB-LD array module capable of being connected in parallel to the direction of an output port of the optical multiplexer 310 is further connected in the embodiment of FIG. 2. To this end, an AWG of the optical multiplexer 310 may be provided with input ports in a direction in which each of the DFB-LD array modules is connected to the optical multiplexer 310.

That is, the apparatus of FIG. 3 may be a form in which three 10-channel 13.3-Gbps DFB-LD array modules 320, 330, and 340 are hybrid-integrated at upper, right, and lower ends of a 30 * 1 silica-based mux 310, respectively.

Through the apparatus of FIG. 3, a 400-Gbps optical signal (30 * 13.3 Gbps) can be generated to an output stage of the AWG. Since the channel modulation speed of each DFB-LD is relatively lower than that (20 Gbps) of FIG. 2, the DFB-LD array module can be configured with relatively low-priced DFB-LDs.

Meanwhile, when the DFB-LD is operated at a modulation speed of 20 Gbps in the structure of the FIG. 3, it is possible to generate a light source having a maximum of 600 Gbps.

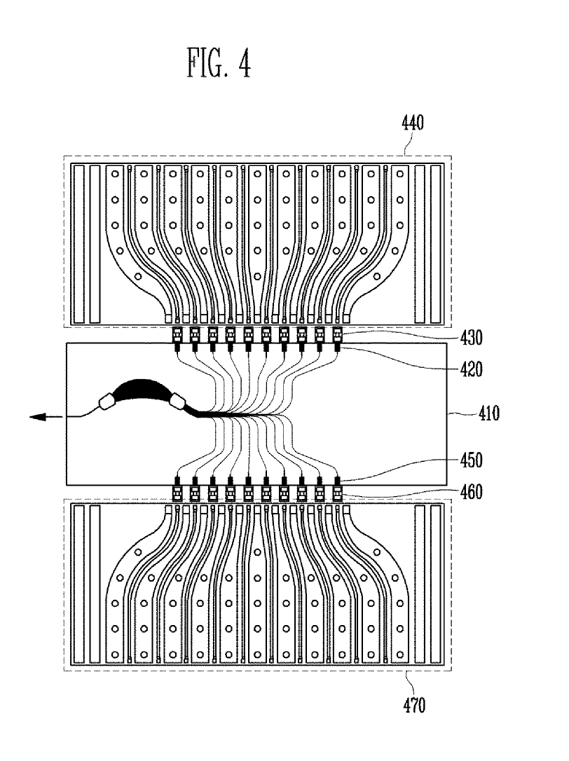

FIG. 4 is a view showing a structure of an apparatus for generating a light source according to a third embodiment of the present disclosure.

The embodiment of FIG. 4 shows a monolithic integration form in which DFB-LD array modules 440 and 470 are manufactured on the same semiconductor substrate as an optical multiplexer 410.

DFB-LDs 430 and 450 and matching resistors 420 and 460, shown in FIG. 4, perform the same functions as the DFB-LD 220 and the matching resistors 230, respectively, and therefore, their detailed descriptions will be omitted.

If the optical multiplexer 410 and the DFB-LD array modules 440 and 470 are integrated on a single semiconductor substrate as shown in FIG. 4, the material refractive index (3.2 to 3.4) of semiconductor is two times greater than that (1.4 to 1.8) of silica, and hence the area of an AWG may decrease to approximately ¼. Thus, as shown in FIG. 4, the size of the apparatus can be reduced as compared with the conventional apparatus, thereby implementing an ultra-compact array light source. Further, the single integrated structure can improve the optical coupling efficiency between the DFB-LD and an input port of the AWG, thereby implementing a low-loss, high-efficiency light source.

In FIG. 4, each of the DFB-LDs 430 and 450 of the DFB-LD array modules 440 and 470 may have the same modulation speed of 20 Gbps as that of FIG. 2. In addition, the AWG of the optical multiplexer 410 is provided with 10 input ports in each of both the directions perpendicular to an output port thereof, to generate a 400-Gbps (20 * 20 Gbps) light source.

Meanwhile, if the DFB-LD array modules 440 and 470 are implemented using a semiconductor material, the performance of the light source is changed depending on a waveguide direction, and hence the number of 10-channel input port columns may be two in the single integrated structure.

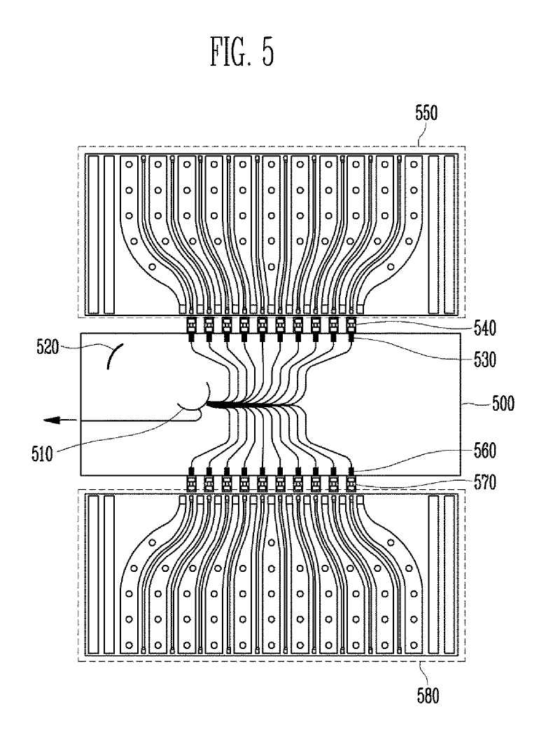

FIG. 5 is a view showing a structure of an apparatus for generating a light source according to a fourth embodiment of the present disclosure.

The apparatus of FIG. 5 is characterized in that a concave grating (CG) 510 instead of the AWG is used in an optical multiplexer 500 in the third embodiment of FIG. 4.

Like the apparatus of FIG. 4, except the above-described feature, the apparatus of FIG. 5 has a monolithic integration form in which the optical multiplexer 500 and DFB-LD array modules 550 and 580 are manufactured on a single semiconductor substrate.

In addition, the DFB-LD array modules 550 and 580 are the same as the DFB-LD array module 400 and 470 of FIG. 4, and DFB-LD 530 and 560 and matching resistor 540 and 570 are the same as the DFB-LD 430 and 450 of FIG. 4. Therefore, their detailed descriptions will be replaced with those of FIG. 4.

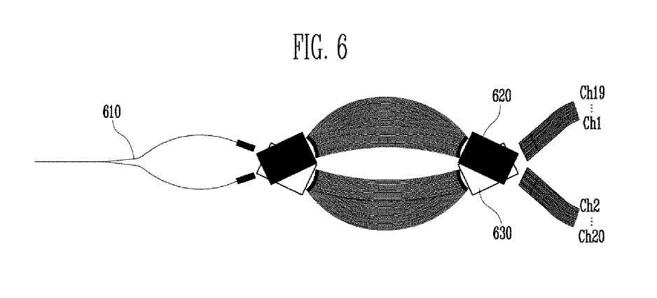

FIG. 6 is a view showing a structure of an optical multiplexer according to an embodiment of the present disclosure.

Specifically, FIG. 6 shows an embodiment obtained by modifying the AWG of FIG. 4.

When the DFB-LDs 420 and 450 are implemented in 20 channels at a wavelength interval of 4 nm in FIG. 4, the total channel interval is 4 * (70−1)=76 nm, and accordingly, the optical multiplexer 410 is to be implemented as 1 * 20 AWGs (a channel interval of 4 nm). That is, if the optical multiplexer and the DFB-LD array modules are manufactured on the single semiconductor substrate, the size of the apparatus decreases, and hence the yield of the apparatus increases. However, the channel interval between the AWGs may become narrow. As the channel interval between the AWGs becomes wide, the crosstalk between channels is improved, and the wavelength allowable range is increased. Also, the allowable range of a structure or material variable error is increased.

Accordingly, in FIG. 6, there is proposed an optical multiplexer including a first AWG 630 connected to odd-numbered channels, a second AWG 620 connected to even-numbered channels, and a coupler 610 that couples outputs of the first and second AWGs 630 and 620.

In the first and second AWGs 630 and 620 of FIG. 6, the channel interval between the odd-numbered channels at a right upper end of the optical multiplexer and the even-numbered channels at a right lower end of the optical multiplexer is 8 nm. If the interval between the odd-numbered channels and the even-numbered channels is moved by 4 nm, the optical multiplexer may be implemented in a structure of 20 channels at a channel interval of 4 nm.

Thus, when the AWG of the existing 1 * 20 multiplexer is implemented with a size of 3750 * 1150 mm², the optical multiplexer of FIG. 6, which is implemented in a structure of 20 channels at a channel interval of 4 nm by allowing the interval between the odd-numbered channels and the even-numbered channels to be moved by 4 nm, can be implemented with a size of 2350 * 700 mm², so that the area of the device is decreased by 38% as compared with the structure of FIG. 4. Further, as the channel interval is increased by two times, the channel wavelength allowable range is also increased by two times.

As described above, according to the configurations, methods, and performances of the embodiments of FIGS. 2 to 6, the modulation speed of the DFB-LD and the number of channels on the FPCB of the DFB-LD array module may be modified in various embodiments, or may be configured by selectively combining all or some of the embodiments. That is, in this specification, a case where the optical modulation speed of the DFB-LD is 10 Gbps or 20 Gbps so as to implement a 400-Gbps light source has been described. However, in various embodiments, DFB-LDs having various optical modulation speeds from a minimum of 5 Gbps to a maximum of 50 Gbps may be applied to the present disclosure.

According to the present disclosure, as the number of channels increases, the size of an optical device is little changed, and RF loss and optical loss do not increase.

According to the present disclosure, the present disclosure can be applied to a method of hybrid integration or single integration.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. An apparatus for generating a light source, the apparatus comprising:
first and second distributed feedback laser diode (DFB-LD) array modules configured to receive an electrical signal input through a plurality of channels and output a plurality of optical signals modulated to have different wavelengths; and
an optical multiplexer configured to output, to one output port, the plurality of optical signals output from the first and second DFB-LD array modules,
wherein the first and second DFB-LD array modules are respectively connected to both sides parallel to the direction of the output port of the optical multiplexer.

2. The apparatus of claim 1, further comprising a third DFB-LD array module connected to the opposite side to the output port of the optical multiplexer.

3. The apparatus of claim 1, wherein the first DFB-LD array module, the second DFB-LD array module, and the optical multiplexer are integrated on a single semiconductor substrate.

4. The apparatus of claim 1, wherein the optical multiplexer includes an arrayed waveguide grating (AWG) configured to multiplex output signals of the first and second DFB-LD array modules and output the multiplexed signals.

5. The apparatus of claim 1, wherein each of the first and second DFB-LD array modules includes:
a plurality of channels configured to transmit/receive the electrical signal;
DFB-LDs configured to respectively receive signals of the plurality of channels and perform optical modulation; and
matching resistors configured to perform impedance matching of the plurality of channels with the DFB-LDs.

6. The apparatus of claim 5, wherein each of the first and second DFB-LD array modules is provided with 10 channels, and the optical modulation speed of the DFB-LDs of the first and second DFB-LD array modules is 5 to 50 Gbps.

7. The apparatus of claim 2, wherein each of the first, second, and third DFB-LD array modules is provided with 10 channels, and the optical modulation speed of the DFB-LDs of the first, second, and third DFB-LD array modules is 5 to 50 Gbps.
